(19) United States
(12) Patent Application Publication
(10) Pub. No.: US 2025/0082132 A1
(43) Pub. Date: Mar. 13, 2025

(54) COOKING STATION WITH EXPANDABLE SIDE SHELF, SYSTEM AND METHOD THEREOF

(71) Applicant: North Atlantic Imports, LLC, Logan, UT (US)

(72) Inventors: James C. Bush, III, Providence, UT (US); Christopher L. Hanks, Nibley, UT (US)

(21) Appl. No.: 18/882,856

(22) Filed: Sep. 12, 2024

Related U.S. Application Data
(60) Provisional application No. 63/537,828, filed on Sep. 12, 2023.

(51) Int. Cl. A47J 37/07; A47J 47/18

(52) U.S. Cl. CPC A47J 37/0786; A47J 37/0713; A47J 47/18

(57) ABSTRACT

A cooking station configured to expand or minimize useable surface space adjacent the cooking station. The cooking station includes a side shelf system coupled to one side of a main body of the cooking station. The side shelf system includes a first shelf, a second shelf, and a track system. The track system is coupled to opposing interior sides of the first shelf and opposing exterior sides of the second shelf such that the track system is configured to facilitate sliding the second shelf relative to an interior of the first shelf.

### CROSS-REFERENCE TO RELATED APPLICATIONS

This application claims the benefit of U.S. Provisional Application No. 63/537,828, filed Sep. 12, 2023, the disclosure of which is hereby incorporated by reference herein in its entirety.

### TECHNICAL FIELD

The present invention relates generally to outdoor cooking stations and, more specifically, the present invention relates generally to side shelves for outdoor cooking stations.

### BACKGROUND

Outdoor cooking has become popular throughout much of the world. Outdoor cooking stations are devices for cooking food by applying heat directly below a cooking surface. Such cooking surface can be a grill grates or a flat top. Further, there are several varieties of outdoor cooking stations, but most fall into one of two categories, either gas fueled or charcoal. Gas fueled grills typically use propane or natural gas as a fuel source, with the gas flame either cooking the food directly or heating grilling elements which in turn radiate the heat necessary to cook the food.

Managing food, cooking utensils and various spices and the like adjacent the cooking surface often becomes problematic for the individual cooking especially in an outdoor setting. To overcome this problem, many outdoor cooking stations include some sort of side shelf attached to the cooking station. Such side shelves are typically positioned adjacent the cooking surface to provide easy access and appropriate management of the cooking area. However, the amount of useable surface space provided by a given side shelf is often insufficient.

### BRIEF SUMMARY OF THE INVENTION

The present invention is directed to embodiments of an outdoor cooking station configured to expand or minimize useable surface space adjacent the cooking station. In one embodiment, the outdoor cooking station includes a main body and a side shelf system. The main body includes one or more heating elements configured to be supported by the main body. The side shelf system is coupled to one side of the main body, the side shelf system including a first shelf, a second shelf, and a track system. The track system is coupled to opposing interior sides of the first shelf and opposing exterior sides of the second shelf. The opposing interior sides of the first shelf define an interior thereunder such that the track system is configured to facilitate sliding the second shelf relative to the first shelf.

In another embodiment, the second shelf is sized and configured to be positioned within the interior of the first shelf. In another embodiment, the track system includes a lock and release lever configured to lock the second shelf within the interior of the first shelf and release the second shelf from the interior of the first shelf such that the side shelf system facilitates expanding and minimizing the useable surface space of the side shelf system. In still another embodiment, the second shelf extends to define a second surface, the second surface extending to define a recess therein, the recess being sized and configured to receive a removable insert. In another embodiment, the removable insert is a bin.

In accordance with another embodiment of the present invention, a side shelf system configured to be coupled to a main body of a cooking station is provided. The side shelf system includes a first shelf, a second shelf and track system. The first shelf extends with opposing interior sides to define an interior of the first shelf, the opposing interior sides coupled to the track system such that the track system is coupled to the opposing interior sides of the first shelf. The second shelf extends with opposing exterior sides, the second exterior sides coupled to the track system such that the second shelf is moveable relative to the first shelf.

In another embodiment, the second shelf is sized and configured to be positioned within the interior of the first shelf. In yet another embodiment, the track system includes a lock and release lever configured to lock the second shelf within the interior of the first shelf and release the second shelf from the interior of the first shelf such that the side shelf system is extendable. In another embodiment, the second shelf extends to define a second surface, the second surface extending to define a recess therein, the recess being sized and configured to receive a removable insert. In a further embodiment, the removable insert is a bin.

In accordance with another embodiment of the present invention, a method for modifying useable surface area associated with a cooking station is provided. The method includes the steps of: providing a main body of a cooking station, the main body including a side shelf system coupled thereto, the side shelf system including a first shelf, a second shelf and a track system, the first shelf extending to define opposing interior side surfaces and the second shelf extending to define opposing exterior side surfaces, the track system positioned between and coupled to the interior side surfaces of the first shelf and the exterior side surfaces of the second shelf; and engaging the track system by pulling on the second shelf so that the second shelf is movable relative to the first shelf to move the side shelf system to an expanded position or a compacted position.

In another embodiment, the engaging step includes expanding the useable surface area by moving the second shelf from an underside of the first shelf. In another embodiment, the engaging step includes minimizing the useable surface area by pushing the second shelf to an underside of the first shelf. In another embodiment, the engaging step includes manually moving a lever to unlock the track system to facilitate moving the second shelf relative to the first shelf. In still another embodiment, the method further includes pulling the second shelf from an underside of the first shelf to expose additional useable surface area provided by the second shelf. In another embodiment, the pulling step includes exposing a removable insert positioned in the second shelf.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective view of an outdoor cooking station, depicting a side shelf system in a use position, according to an embodiment of the present invention;

FIG. 1A is an exploded view of the outdoor cooking station, depicting the cooking station having a griddle, according to another embodiment of the present invention;

FIG. 2 is a front view of the outdoor cooking station, depicting the side shelf system in a compact position, according to another embodiment of the present invention;

FIG. 3 is a top view of the outdoor cooking station, depicting the side shelf system in the compact position, according to another embodiment of the present invention;

FIG. 4 is a cross-sectional view of the outdoor cooking station taken along section line 4-4 of FIG. 3, according to another embodiment of the present invention;

FIG. 5 is an upper perspective view of a side shelf system, depicting the side shelf system in a first position, according to another embodiment of the present invention;

FIG. 6 is a cross sectional view of the side shelf system taken along section line 6-6 of FIG. 5, according to another embodiment of the present invention;

FIG. 7 is an upper perspective view of the side shelf system, depicting the side shelf system in a partially expanded position and depicting portions of a track system, according to another embodiment of the present invention;

FIG. 8 is an upper perspective view of the side shelf system, depicting the side shelf system in a fully expanded, second position and depicting portions of the track system, according to another embodiment of the present invention;

FIG. 9 is an underside cross-sectional view of the side shelf system taken along section line 9-9 of FIG. 8, depicting portions of the track system with the side shelf system in the fully expanded, second position, according to another embodiment of the present invention;

FIG. 10 is a side view of a portion of the track system, depicting the track system in a locked position, according to another embodiment of the present invention;

FIG. 11 is a side view of the portion of the track system, depicting the track system in an unlocked position, according to another embodiment of the present invention;

FIG. 12 is a cross-sectional view of the side shelf system taken along line section 12-12 of FIG. 5, depicting the side shelf system in the first position and the track system in the locked position, according to another embodiment of the present invention;

FIG. 13 is a cross-sectional view of the side shelf system taken along section line 13-13 of FIG. 8, depicting the side shelf system in the fully expanded, second position and the track system in the locked position, according to another embodiment of the present invention;

FIG. 14 is a cross-sectional view of the side shelf system taken along section line 14-14 of FIG. 5, depicting the track system in a locked position and the shelf system in the first position, according to another embodiment of the present invention;

FIG. 15 is a cross-sectional view of the side shelf system taken along section line 15-15 of FIG. 7, depicting the track system in an unlocked position and the shelf system in a partially expanded position, according to another embodiment of the present invention;

FIG. 16 is a cross-sectional view of the side shelf system taken along section line 16-16 of FIG. 8, depicting the track system in an unlocked position and the shelf system in the fully expanded, second position, according to another embodiment of the present invention;

FIG. 17 is an upper perspective view of another embodiment of a side shelf system, depicting the side shelf system in a fully expanded, second position with a removable insert positioned therein, according to another embodiment of the present invention;

FIG. 18 is a front view of the side shelf system, depicting the side shelf system in the fully expanded, second position with a removable insert positioned therein, according to another embodiment of the present invention; and

FIG. 19 is a underside cross-sectional view of the side shelf system taken along section line 19-19 of FIG. 17, according to another embodiment of the present invention.

### DETAILED DESCRIPTION OF THE INVENTION

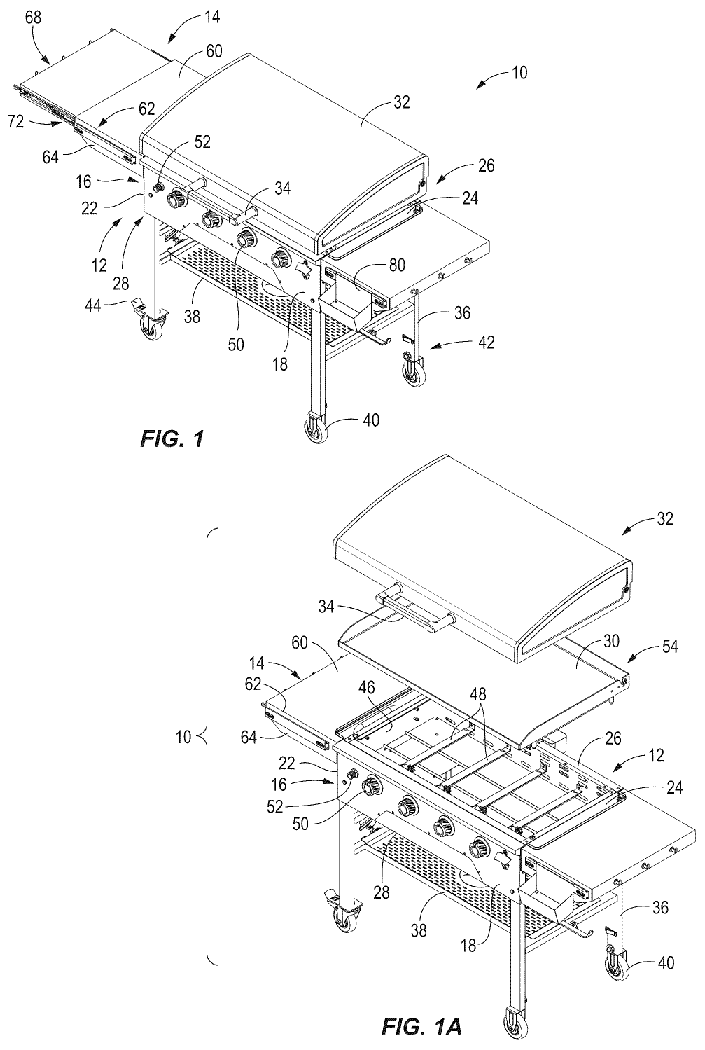

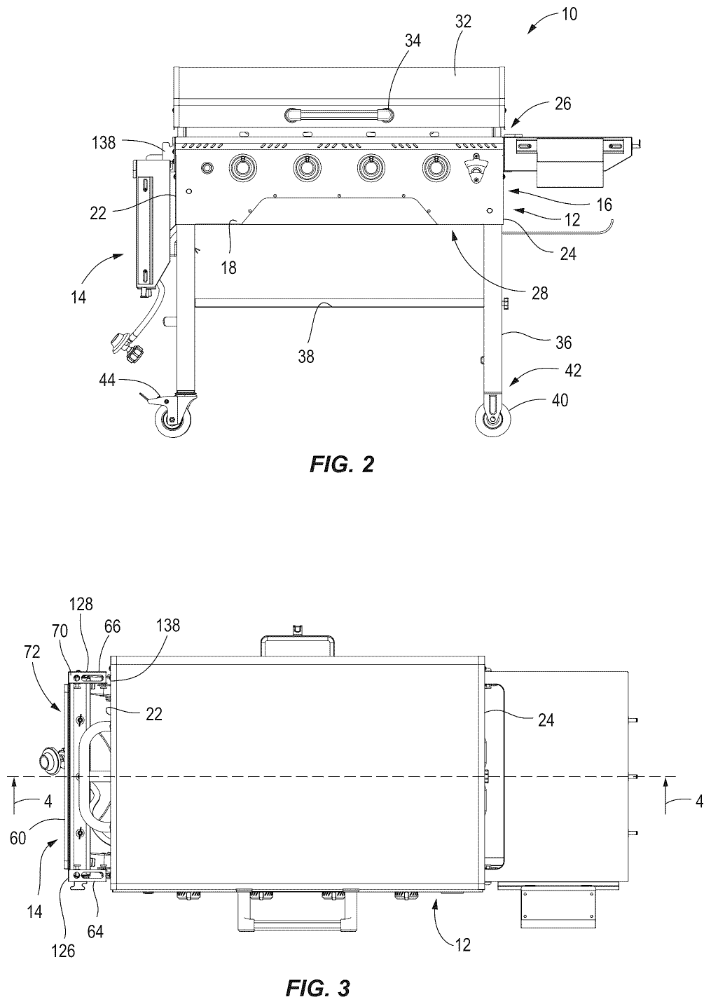

Referring to FIGS. 1, 1A and 2, an outdoor cooking station 10 including a main body 12 and side shelf system 14 is provided. Such cooking station 10 may be configured to be compactable and portable such that when the cooking station 10 is in use the side shelf system 14 may be modified to a compact, folded position as well as be modified to minimize or expand the surface area or space of the side shelf system 14. The cooking station 10 may include the main body 12 extending with multiple panels 16 where at least one of two opposing panels or sides may include the side shelf system 14 pivotably coupled thereto. The side shelf system 14 may include a first shelf 88 coupled to a second shelf 90 with a track system 102, the second shelf 90 moveable relative to the first shelf 88 to minimize or expand the useable surface area of the side shelf system (see also FIGS. 5 and 8). In this manner, the side shelf system 14 may modify the foot print of the cooking station 10 as well as the useable surface area to assist the user of the cooking station 10. Further, the side shelf system 14 may also be configured to include removable inserts and attachments, discussed further herein, which may hold food or tools or provide additional surface area to further assist the user of the cooking station 10.

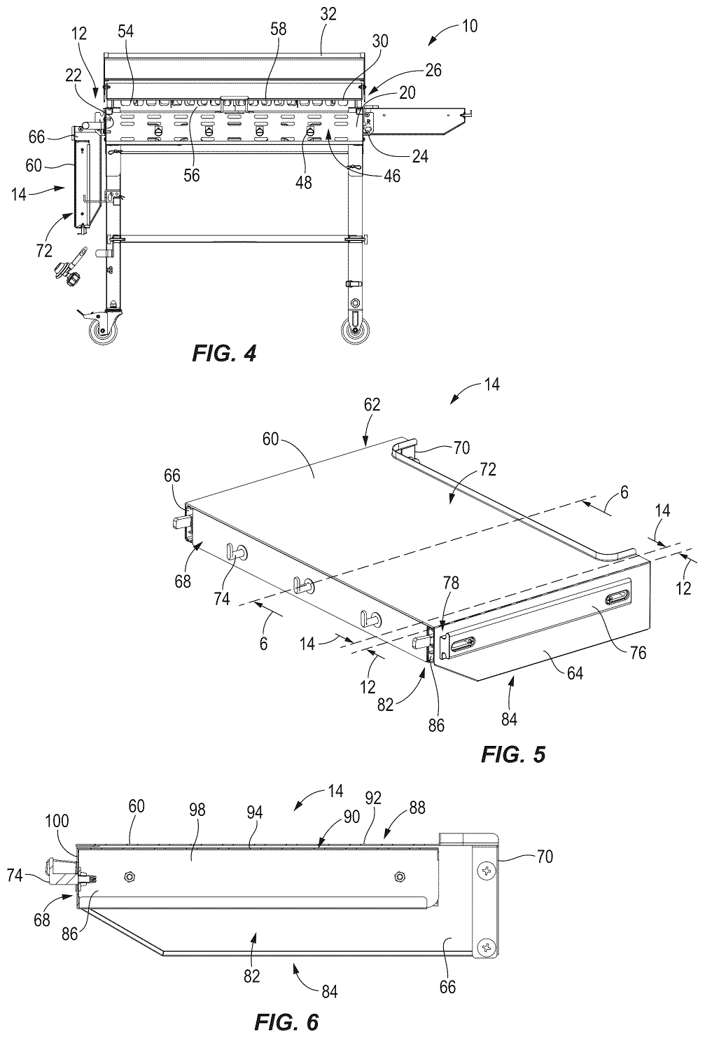

As previously set forth, the cooking station 10 may include the main body 12 with the multiple panels 16 to define a front panel 18, a rear panel 20 (FIG. 4), a left panel 22, and a right panel 24. The front panel 18 and rear panel 20 (FIG. 4) may extend parallel to one another on opposing sides of the main body 12. Further, the front panel 18 and rear panel 20 (FIG. 4) may be coupled to the left panel 22 and right panel 24 on opposing ends of the left and right panels 22, 24, respectively. The left panel 22 and right panel 24 may extend parallel to one another and perpendicular to the front panel 18 and rear panel 20 (FIG. 4). The front panel 18, rear panel 20 (FIG. 4), left panel 22, and right panel 24 may extend to define an upper periphery 26 and lower periphery 28. The upper periphery 26, or adjacent structure, may be sized and configured to support a cooking surface 30, such as a griddle 54, to be positioned thereon or adjacent thereto. A lid 32 or hood may be included and positioned on the upper periphery 26 of the main body 12 such that the lid 32 may extend over the entirety of the cooking surface 30 to enclose the cooking surface 30. Further, the lid 32 may be pivotably coupled to the griddle 54 or the main body 12, where the lid 32 may pivot from enclosing the griddle 54 the cooking surface 30 (FIG. 4) to an open position to allow access to the griddle 54. The lid 32 may include a handle 34 positioned thereon configured to allow for a user to pivot the lid 32 between closed and open positions.

The lower periphery 28 of the main body 12 may include legs 36 extending therefrom such that the legs may be positioned on the floor or ground surface to suspend the main body 12 to a desirable height. In one embodiment, the legs 36 may be pivotably coupled to the lower periphery 28 of the main body 12, for storage and transporting purposes, such that the legs 36 may fold towards the lower periphery 28 of the main body 12 and rest in line with the multiple panels 16, thereby, assisting in the portability of the cooking station 10. More specifically, the legs 36 may pivot inwards to make the cooking station 10 compact such that the legs 36 may extend parallel to the front panel 18 and rear panel 20 (FIG. 4). In another embodiment, the legs 36 may be locked upright such that the legs 36 may not be pivotable relative to the main body 12. The legs 36 may include a lower shelf 38 extending between the legs 36. In one embodiment, the lower shelf 38 may assist in preventing the legs 36 from folding inwards towards the main body 12. Further, the lower shelf 38 may be sized and configured for storage of cooking utensils, spices, or other tools, as desired by the user. The legs 36 may also include wheels 40 positioned adjacent a bottom end 42 of the legs 36. The wheels 40 may include brakes 44, for example. Such wheels 40 associated with the legs 36 of the cooking station 10 may further assist in the portability of the cooking station 10.

Now with reference to FIGS. 1, 1A and 4, the front panel 18, rear panel 20, left panel 22, and right panel 24 may extend to define an inner portion 46 of the main body 12. The inner portion 46 may include one or more heating elements, such as burners 48, positioned therein, the burners 48 supported by a framework of the main body 12. The burners 48 may extend in a tube shape, or other shape, such as, for example a U-shape or H-shape, extending between the front panel 18 and the rear panel 20 of the main body 12. Further, the burners 48 may be positioned directly below the cooking surface 30, such as the griddle 54, where the burners 48 may be sized and configured to allow for fuel, such as propane or natural gas, from a fuel source to flow therethrough and provide heat to the cooking surface 30, upon the fuel being ignited. The inner portion 46 of the main body 12 may also include, and be associated with, the necessary components, such as, gas lines, valves, clamps, etc., as known to one of ordinary skill in the art, such that the burners 48 and the cooking station 10 may properly function. The front panel 18 may include burner knobs 50 configured to open and close the fuel from the burners 48 such that fuel may flow to the burners 48 positioned within the inner portion 46 of the main body 12. The front panel 18 may also include an ignitor 52, or in a further embodiment, the ignitor 52 may be coupled to the burner knobs 50, such that, upon the burner knobs 50 being turned the ignitor 52 may ignite the fuel flowing through the burners 48. As set forth, the fuel associated with the burners 48 may be propane or natural gas and, as such, the burners may be flame type burners 48, sized and configured to heat the cooking surface 30 of the griddle 54.

As previously set forth, the lid 32 or hood may be positioned adjacent to or on the upper periphery 26 of the main body 12 to enclose the griddle 31. The lid 32 may be sized and configured to trap heat between the cooking surface 30 and the lid 32 such that the food may cook faster. Further, the lid 32 may also be sized and configured to protect the cooking surface 30 from the elements as it is outdoors or in storage. The cooking surface 30 may be a flat cooking surface, such as a griddle 54. Such griddle 54 may be sized and configured to be positioned adjacent the upper periphery 26 to extend over the inner portion 46 of the main body 12. The griddle 54 may include an understructure 56 sized and configured to minimize thermal fatigue to the griddle 54. The understructure 56 may include multiple strengthening structures, such as ribs with openings 58 defined therein to manipulate heat flow from under the griddle 54. Further detail of a griddle with the understructure 56 is disclosed in commonly assigned U.S. Non-Provisional patent application Ser. No. 17/725,630, filed Apr. 21, 2022, and entitled COOKING STATION AND GRIDDLE WITH UNDERSTRUCTURE AND METHOD THEREOF, the disclosure of which is incorporated herein in its entirety.

With reference to FIGS. 1A, 3, 4, and 5 as previously set forth, the side shelf system 14 may be sized and configured to assist in increasing or decreasing the useable surface area, as desired by the user, for cooking utensils and various food items to be positioned thereon. The side shelf system 14 may include a shelf surface 60 extending flat and parallel to the cooking surface 30, upon the side shelf system 14 being in a use position, such that, food or utensils may be positioned thereon. The shelf surface 60 may extend to a periphery 62, the periphery extending along a front side 64, a rear side 66, a left side 68, and a right side 70 to define the structure of a side shelf 72. The side shelf system 14 may be pivotably coupled to at least one of the left panel 22 and the right panel 24 of the main body 12 such that the side shelf system 14 may pivot from the use position (FIG. 1) to the folded position or a compact position (FIG. 2). The use position may correlate with the side shelf system 14 extending parallel to the cooking surface 30. The folded position may correlate to the side shelf system 14 extending generally perpendicular to the cooking surface 30. With the side shelf system 14 being coupled to the left panel 22, the right side 70 of the side shelf 72 may be positioned against or near the left panel 22, and, with the side shelf system 14 being coupled to the right panel 24, the left side 68 of the side shelf 72 may be positioned against or near the right panel 24. The left side 68 and right side 70 of the side shelf 72 may mirror one another when the side shelf system 14 is positioned on the left panel 22 and/or the right panel 24, respectively. More specifically, the general structure of the side shelf system 14 may mirror one another. However, attachments of the side shelf system 14 may be provided on one side shelf system 14 and not be mirrored on the other side shelf system 14 attached to the opposing panel. As the description of the side shelf system 14 is provided below, the side shelf system 14 will be described as being coupled to the left panel 22, however, it should be understood that the side shelf system 14 may also be coupled to the right panel 24 and, as such, would be similarly described.

Now with reference to FIGS. 1 and 5, as previously provided the side shelf system 14 may include the shelf surface 60 extending to the periphery 62 coupled to the front side 64, rear side 66, left side 68, and right side 70. The front side 64, rear side 66, left side 68, and right side 70 may extend generally perpendicular to the shelf surface 60. The front side 64 and rear side 66 may extend parallel to one another and be coupled to the left side 68 and right side 70 at opposing ends, respectively. Further, the front side 64 and rear side 66 may extend perpendicular to the left side 68 and right side 70. Similar to the front side 64 and rear side 66, the left side 68 and right side 70 may extend parallel to one another and perpendicular to the front side 64 and rear side 66.

With reference to FIGS. 5 and 6, the left side 68 of the side shelf system 14 may include multiple hooks 74 positioned thereon extending with a L-shape. The multiple hooks 74 may be configured for hanging cooking utensils or the like thereto. Further, the multiple hooks 74 may be positioned equidistant from one another allowing for ample space for cooking utensils or other such items to be positioned thereon. The front side 64 of the side shelf system 14 may include various structures for holding tools, such as a clip-on structure 76 or a magnetic strip, that may extend along a length of the front side 64. The clip-on structure 76 may capture similar opposing structure, such as, for example, opposing clip-on structure with a container 80 (FIG. 1) or cup holder. The multiple hooks 74, clip-on structure 76, or magnetic strip may be positioned on any one of the front side 64, left side 68, or right side 70 of the side shelf system 14.

The front side 64, rear side 66, left side 68, and right side 70 may extend with a height so as to define an interior 82, or lower side 84 of the side shelf system 14. The height may extend similarly for the front side 64, rear side 66, left side 68, and right side 70 of the side shelf system 14. The front side 64 and rear side 66 may extend with a taper from the right side 70 to the left side 68 of the side shelf system 14. In this configuration, the front side 64 and rear side 66 may be greater in height at the coupling of the right side 70 than at the left side 68 of the side shelf system 14. The interior 82 may be sized and configured to include extension structure 86 positioned therein configured to be pulled out of the interior 82 of the side shelf system 14. The extension structure 86 may be a secondary shelf, or, in a further embodiment, the extension structure may be a drawer.

With reference to FIGS. 6, 7, and 8, as previously set forth, the side shelf system 14 may be configured to expand such that additional useable surface space may be provided. As such, the side shelf system 14 may include a first shelf 88 and a second shelf 90, where the first shelf 88 may be the outer structure of side shelf system 14. Such outer structure of the side shelf system may include the shelf surface 60, front side 64, rear side 66, and right side 70. The second shelf 90 may be the extension structure 86, as previously set forth, such that, the second shelf 90 may be positioned within the interior 82 of the first shelf 88. As such, upon the side shelf system 14 being in a minimized, first position, the second shelf 90 may be positioned within the first shelf 88. Further, upon the side shelf system 14 being in the expanded, second position, the second shelf 90 may be exposed from the first shelf 88.

The first shelf 88 may extend with a first surface 92. The first surface 92 may also be the shelf surface 60, previously described. As such, the first shelf 88 may include the first surface 92 coupled to the front side 64, rear side 66, and right side 70 to define the interior 82. The interior 82 of the first shelf 88 may be sized and configured to position the second shelf 90 therein. In other words, the structure of the first shelf 88, such as the first surface 92, front side 64, rear side 66, and right side 70, may extend to contain the second shelf 90. The second shelf 90 may include a second surface 94 that may extend parallel to the first surface 92. The second surface 94 of the second shelf 90 may extend to a front wall 96, rear wall 98, and left wall 100, such that the front wall 96, rear wall 98, and left wall 100 may extend generally perpendicular relative to the second surface 94, similar to the first shelf 88. The side shelf system 14 and the second shelf 94 may include a common wall such that the left side 68 of the side shelf system 14 may be left wall 100. As such, upon the side shelf system 14 being in the minimized first position, the first shelf 88 may extend over each of the second surface 94, front wall 96, and rear wall 98, leaving the left wall 100 exposed. The left wall 100 may include the multiple hooks 74 and, or a click-on structure, or a magnetic strip, similar to that described above.

With reference to FIGS. 8 and 9, the second shelf 90 of the side shelf system 14 may be coupled to the first shelf 88 by means of a track system 102. The track system 102 may be coupled to the first shelf 88 along interior sides of the front side 64 and rear side 66. Further, the track system 102 may also be coupled to the second shelf 90 along exterior sides of the front wall 96 and rear wall 98 of the second shelf 90. The track system 102 may include various track components and parts so as to define a front track 104 and rear track 106, for example. As such, the front side 64 and rear side 66 of the first shelf 88 may be coupled to the front wall 96 and rear wall 98 of the second shelf 90, respectively, by means of the track system 102. Further, the track system 102 may extend longitudinally along a length of the front side 64 and rear side 66 of the first shelf 88 and the front wall 96 and rear wall 98 of the second shelf 90. The track system 102 may be configured to facilitate movement of the second shelf 90 such that the second shelf 90 may slide from the interior 82 or interior sides of the first shelf 88 so that the side shelf system 14 may be moved from the minimized, first position (FIG. 5) to the expanded, second position, as depicted in FIG. 8. The front track 104 and rear track 106 of the track system 102 may each include a first member 108, a gliding member 110, and a second member 112. The first member 108 may be coupled to the interior 82 or interior sides of the first shelf 88 along both the front side 64 and rear side 66 of the first shelf 88. The first member 108 may be sized and configured to be stationary and slidingly hold the gliding member 110 therein. The gliding member 110 may be moveably coupled to the first member 108 such that the gliding member 110 may move along a length of the first member 108. Further, the gliding member 110 may be configured to hold the second member 112 therein. The second member 112 may be fixedly coupled to exterior sides of the front wall 96 and rear wall 98 of the second shelf 90 while also being slidingly coupled to the gliding member 110. With this arrangement, the gliding member 110 may be configured to provide sliding or gliding movement of the second shelf 90 relative to the first shelf 88. Further, the gliding member 110 may also be configured to provide sliding or gliding movement of the second member 112, such that, the second shelf 90 may be completely extended from the interior 82 of the first shelf 88 so that the side shelf system 14 may be in the expanded, second position.

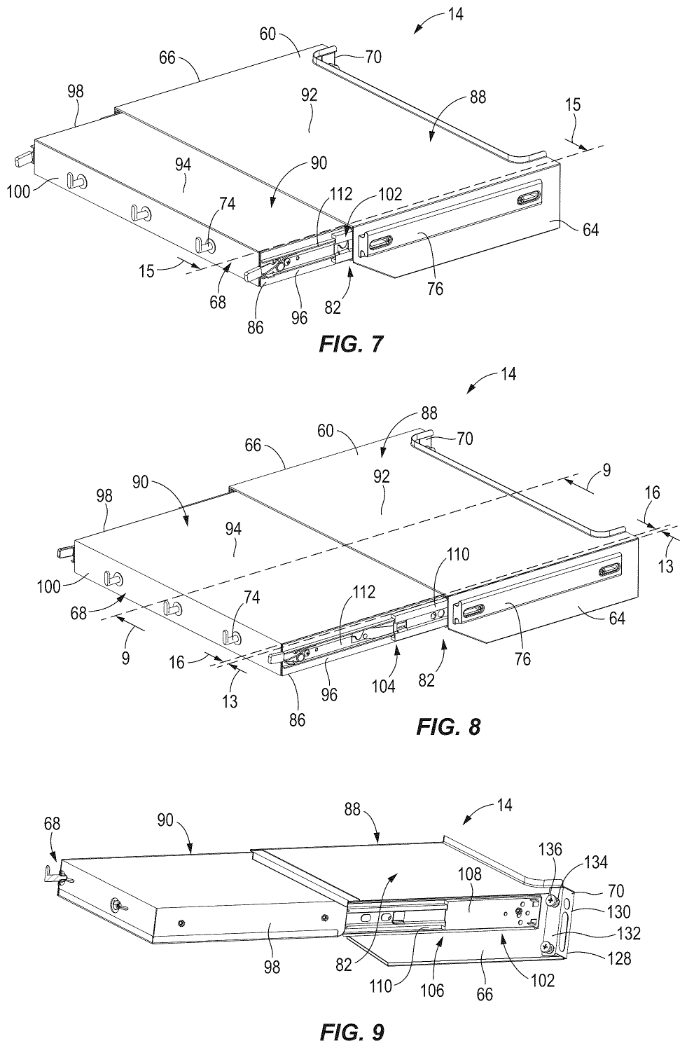

With reference to FIGS. 7, 10, and 11, the side shelf system 14 may include a means for locking the second shelf 90 within the interior 82 of the first shelf 88 such that the side shelf system 14 may be locked in the minimized, first position or in the expanded, second position. The second member 112 may include a front lever 114 and a rear lever 116 positioned therein. The rear lever 116 may be positioned between two opposing ends of the second member 112, where one of the two opposing ends may include the front lever 114 positioned thereon. The front lever 114 and rear lever 116 may be interconnected to one another such that an action provided by the front lever 114 may also cause the rear lever 116 to have a reaction. The front lever 114 may be spring biased upwards and locked, such that the rear lever 116 may be resting somewhat downwards. The front lever 114 may be manually pushed downwards which may result in the rear lever 116 moving upwards, unlocking the track system 102. In this manner, upon the front lever 114 being positioned upwards, then the rear lever 116 may be positioned downwards. Upon the rear lever 116 being positioned downward, the track system 102 may be locked. In this manner, the front lever 114 may be manually moved downward to unlock the track system 102.

Now with reference to FIGS. 11, 12, and 13, the front lever 114 and rear lever 116 may be configured to lock the side shelf system 14 in the minimized, first position, as shown in FIG. 12. The gliding member 110 of the track system 102 may be positioned over the second member 112 such that the front lever 114 and rear lever 116 may be partially concealed by the gliding member 110. The front lever 114 may partially protrude from the second member 112 past the left wall 100 of the second shelf 90 such that the front lever 114 may be easily accessible to lock and unlock a position of the second shelf 90 relative to the first shelf 88. The second member 112 may be locked to the gliding member 110 in a first position (FIG. 12) or second position (FIG. 13), where the first position corresponds to the side shelf system 14 being in the minimized, first position and the second position corresponds to the side shelf system 14 being in the expanded, second position. The gliding member 110 may include a first slot 118 and a second slot 120 both of which may extend to define an edge 122 extending therefrom. The rear lever 116 may include an arm 124 extending in a u-shape or other shape such that the arm 124 may latch or hook onto the gliding member 110, such as latching onto the edge 122 of either the first slot 118 or second slot 120 of the gliding member 110. In this manner, the rear lever 116 may lock the second member 112 to the gliding member 110. The first slot 118 may correspond to the first position, or, in other words, the first slot 118, having the arm 124 of the rear lever 116 locked thereon, may lock the second shelf 90 into the first shelf 88 such that the side shelf system 14 may be in the minimized, first position. Likewise, the second slot 120 may correspond to the second position, or, the second slot 120, having the arm 124 of the rear lever 116 locked thereon, may lock the second shelf 90 extended or expanded from the first shelf 88 such that the side shelf system 14 may be in the expanded, second position. As such, the second position, or second slot 120 having the arm 124 of the rear lever 116 locked thereon, may maintain the second shelf 90 from retracting back into the first shelf 88 during use. Likewise, the first position, or first slot 118 having the arm 124 of the rear lever 116 locked thereon, may maintain the second shelf 90 from expanding from the first shelf 88 during storage or transportation.

Now with reference to FIGS. 2, 3, and 9, in one embodiment, as previously set forth, the side shelf system 14 may pivot from the use position to the folded position. The right side 70 may extend with a front end 126 and a rear end 128. In this configuration, the front end 126 and rear end 128 of the right side 70 may be coupled to the left panel 22 of the main body 12, where the front end 126 and rear end 128 of the right side 70 may be pivotably coupled to the left panel 22. The front end 126 and rear end 128 may both include an outward face 130 and an inward face 132. The outward face 130 may be configured to extend parallel to the left side 68 of the side shelf system 14, while the inward face 132 may extend parallel to the front side 64 or rear side 66 of the side shelf system 14. The outward face 130 and the inward face 132 may extend perpendicular to one another. Further, the outward face 130 may face towards the left panel 22 of the main body 12, upon the side shelf system 14 being coupled to the left panel 22 of the main body 12. The inward face 132 of the front end 126 and rear end 128 may face towards one another and include pin holes 134 positioned thereon. The pin holes 134 may be sized and configured for a pin 136 to extend therethrough and couple the side shelf system 14 to the left panel 22. The left panel 22 of the main body 12 may include brackets 138 extending therefrom. Such brackets 138 may include slot structure sized and configured to receive the pin 136 to extend through the brackets 138 of the left panel 22 of the main body to pivotably couple to the inward face 132 of the front end 126 and rear end 128 of the side shelf system 14. In this configuration, the brackets 138 may extend parallel to the inward face 132 of the front end 126 and rear end 128 of the right side 70 of the side shelf system 14.

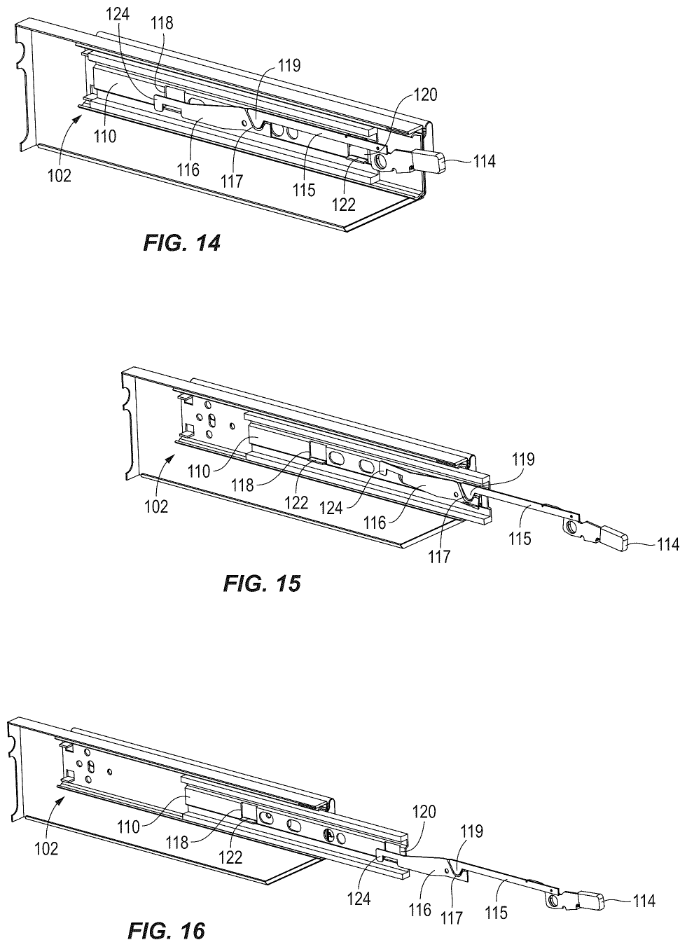

With reference to FIG. 14-16, as previously set forth, the track system 102 may include a means for locking the track system 102 such that the side shelf system 14 (FIG. 13) may lock in either the compact minimized, first position or the expanded, second position. Further, the front lever 114 may be interconnected to the rear lever 116, where the rear lever 116 may include the arm 124 which may lock to the edge 122 of either the first slot 118 or the second slot 120 of the gliding member 110. The front lever 114 may include a connecting member 115 extending from the front lever 114. The rear lever 116 may include a groove 117 sized and configured for a rounded portion 119 of the connecting member 115 to engage with. The rounded portion 119 may be sized and configured to fit into the groove 117 such that the rear lever 116 and connecting member 115 may interlock with each other. The connecting member 115 may be configured to provide leverage to the front lever 114 such that the front lever 114, through the connecting member 115, may provide either upwards or downwards movement to the rear lever 116. As previously provided, the front lever 114 may be spring biased upwards such that when the front lever 114 may be extending upwards, the rounded portion 119 of the connecting member 115 may be resting in the groove 117 of the rear lever 116, holding the rear lever 116 on the edge 122 of the first slot 118 or second slot 120. Likewise, when the front lever 114 may be pushed downwards, the connecting member 115 may be lifted such that the rounded portion 119 may release the groove 117 and the rear lever 116 may lift upwards.

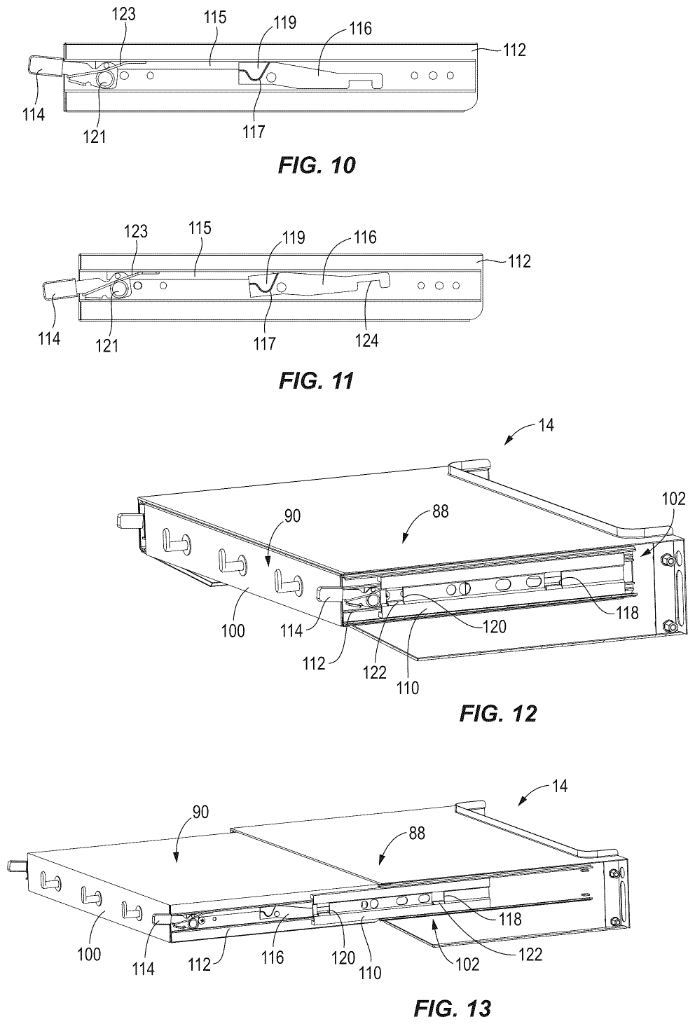

Now with reference to FIGS. 10, 11, 14, and 15, as previously provided, the front lever 114 may be spring biased upwards. Such upward position of the front lever 114 may correlate to the track system 102 being locked. The front lever 114 may include a dowel 121 and spring 123, where the dowel 121 may jut somewhat out from the front lever 114. The spring 123 may be sized and configured to coil around the dowel 121 and provide tension to the connecting member 115. When the front lever 114 may be extending upwards, the spring 123 may be in a relaxed state or minimized tension to the connecting member 115. In this configuration, the connecting member 115 and rounded portion 119 may rest within the groove 117 of the rear lever 116. When the front lever 114 may be extending downwards, the spring 123 may be in a more tensed state, providing tension to the connecting member 115. In this configuration, the rounded portion 119 may provide pressure downwards and against the groove 117 of the rear lever 116, pulling the rear lever 116 upwards. In another embodiment, the spring 123 may continuously bias the lever upwards, but be less tense when the lever is positioned upward.

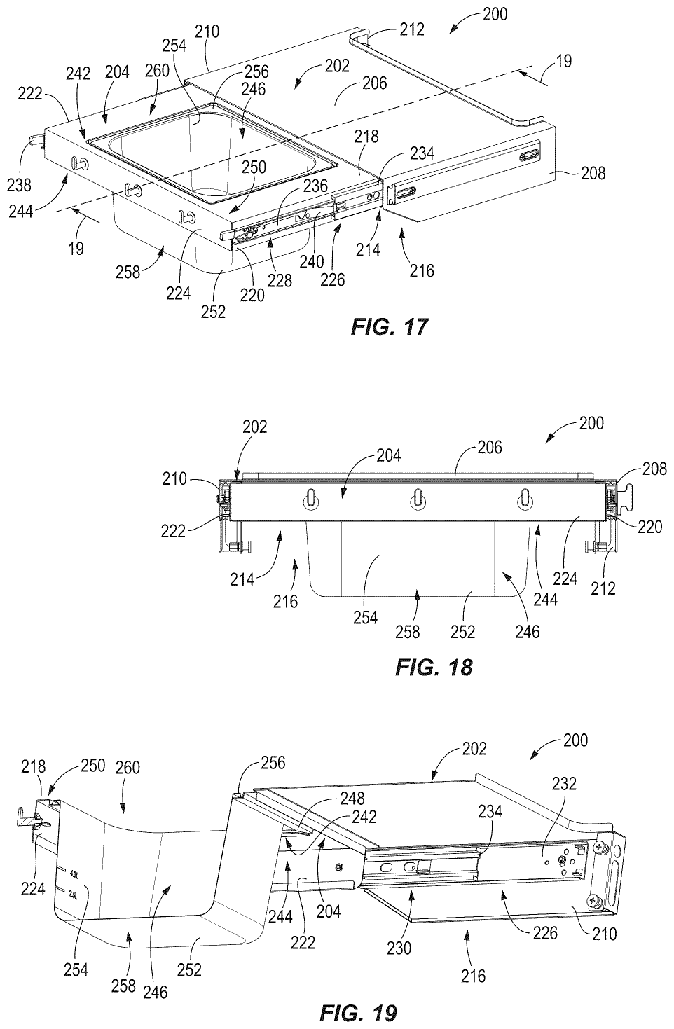

With reference to FIGS. 17 and 18, another embodiment of a side shelf system 200 including a first shelf 202 and a second shelf 204 is provided. The side shelf system 200 may be configured to provide additional surface space by means of expanding from a compact position to an expanded position. Similar to previous embodiments, the side shelf system 200 may include the first shelf 202 extending with a first surface 206 to a front side 208, a rear side 210, and a right side 212. The front side 208, rear side 210, and right side 212 may extend perpendicular to the first surface 206 to define an interior 214, or lower side 216, of the first shelf 202. The interior 214, also referred to as the lower side 216, may be positioned below the first surface 206. The front side 208 and rear side 210 may extend parallel to one another and be coupled to opposing ends of the right side 212. The second shelf 204 may extend with a second surface 218 to a front wall 220, a rear wall 222, and a left wall 224, where the second shelf 204 may be sized and configured to be positioned within the lower side 216 of the first shelf 202. The front wall 220 and rear wall 222 of the second shelf 204 may extend parallel with one another and may be coupled to opposing ends of the left wall 224. The left wall 224 of the second shelf 204 and the right side 212 of the first shelf 202 may extend parallel to one another. Further, the left wall 224 of the second shelf 204 may extend somewhat flush with the front side 208 and rear side 210 of the first shelf 202 when the second shelf 204 may be positioned within the lower side 216 of the first shelf 202.

Now with reference to FIGS. 17 and 19, the first shelf 202 and second shelf 204 may be coupled to one another by means of a track system 226. The track system 226 may be configured to provide movement to the second shelf 204 such that the second shelf 204 may be moved relative to the first shelf 202 to either minimize or expand the useable surface area. The track system 226 may include a front track 228 and a rear track 230. The front track 228 may couple the front side 208 of the first shelf 202 to the front wall 220 of the second shelf 204 and the rear track 230 may couple the rear side 210 of the first shelf 202 to the rear wall 222 of the second shelf 204. Each of the front and rear tracks 228, 230 may include a first member 232, a gliding member 234, and a second member 236. One of the first members 232 may be fixed to the front side 208 as well as the rear side 210 of the first shelf 202 such that the first member 232 may extend along the length of the front side 208 and rear side 210. The second member 236 may be fixed to both the front wall 220 and rear wall 222 of the second shelf 204, such that one of the second members 236 may extend along the length of the front wall 220 and rear wall 222. The first member 232 may include the gliding member 234 positioned thereon, where the gliding member 234 may be moveably coupled to the first member 232. The second member 236 may also include the gliding member 234 positioned thereon, where the second member 236 may be moveably coupled to the gliding member 234. The gliding member 234 may provide initial movement of the second shelf 204 from the lower side 216 of the first shelf 202 by means of sliding from the lower side 216 of the first shelf 202 such that, the second shelf 204 may be partially extended from the first shelf 202. The second member 236 may slide the length of the gliding member 234, such that, the second shelf 204 may be extended completely from the lower side 216 of the first shelf 202. The track system 226 may also include a front lever 238 coupled to the second member 236 such that the front lever 238 may extend past the left wall 224 of the second shelf 204. The front lever 238 may be interconnected to a rear lever 240 such that the front lever 238 may control the rear lever 240. The front lever 238 and rear lever 240 may be configured to lock the track system 226 in the compact position or expandable position, similar to the embodiment described above. Further, the front lever 238 may be spring biased in and upward and locked position, such that when the front lever 238 may be in an upward locked position the rear lever may be positioned downwards. The front lever 238 may be manually moved downwards which may result in the rear lever 240 moving upwards, unlocking the track system 226 such that the second shelf 204 may be removed from the lower side 216 of the first shelf 202, or, pushed back into the lower side 216 of the first shelf 202. Further, the front lever 238 and rear lever 240 may lock the second shelf 204 in the compact position such that the second shelf 204 may not slide from the first shelf 202, or, the front lever 238 and rear lever 240 may lock the second shelf in the expanded position such that the second shelf may not retract while in use.

With reference to FIGS. 17-19, the second shelf 204 may include the second surface 218 extending perpendicular to the front wall 220, rear wall 222, and left wall 224 in a flat manner. The second surface 218 of the second shelf 204 may include a recess 242 or opening defined therein. The recess 242 may extend below the level of the second surface 218. The recess 242 may be open to a bottom side 244 of the second surface 218 such that an insert 246 may be positioned therein. The recess 242 may be a square or rectangular shape, or in other embodiments a circular shape, sized and configured for the insert 246 to be positioned therein and/or extending therethrough. Further, the recess 242 may include a lower edge 248 configured to hold a flange of the insert 246 such that the insert 246 may not fall through the bottom side 244 of the second shelf 204. In one embodiment, the recess 242 may be positioned somewhat in the center of the second surface 218 of the second shelf 204, where the insert 246 may be lifted upwards to be removed. In another embodiment, the recess 242 may be positioned along a second shelf periphery 250 such that one may slide the insert 246 out of the recess 242.

The insert 246 may be a bin 252, a cutting board, or the like. The insert 246 may be configured to provide additional preparation space or storage. The insert 246, being the bin 252, may include a bowl 254 and an upper surface 256. The bowl 254 may extend somewhat perpendicular to the second surface 218 away from the upper surface 256 of the bin 252 towards a lower end 258 of the bin 252. The upper surface 256 may extend parallel to the second surface 218 and be configured to rest on the lower edge 248 of the recess 242 such that, when the upper surface 256 of the bin 252 engages with the lower edge 248 of the recess 242, the bin 252 may rest within the recess 242. The bin 252 may be configured to hold food therein and may be easily removable such that a user may remove the bin 252 from the recess 242 when the side shelf system 200 may be in the expanded position. The side shelf system 200 may be in the compact position, where the second shelf 204 is positioned within the lower side 216 of the first shelf 202. In this configuration, the bin 252, or the insert 246, may extend from the second surface 218 of the second shelf 204 past the lower side 216 of the first shelf 202. Further, the upper surface 256 or an upper end 260 of the bin 252 may be covered by the first surface 206 of the first shelf 202 when the second shelf 204 may be positioned within the lower side 216 of the first shelf 202 such that the side shelf system 200 may be in the compact position. As such, the side shelf system 200 of this embodiment may include additional functionality to hold the insert 246 in the second shelf 250 such that, upon the side shelf system 200 being in the expanded position, the insert 246 may be accessible and, upon the side shelf system 200 being in the compact position, the insert may be hidden below the first shelf 202.

The various structural components of the embodiments of the cooking station and the side shelves associated with the cooking station set forth herein may be formed from metallic materials, such as steel, stainless steel, aluminum, copper, or any other suitable metallic material, or some components may be formed from one or more polymeric materials, as well as any other materials needed to form and manufacture the various components of the cooking station, as known by one of ordinary skill in the art. Further, the structural components of the cooking station may be formed by employing known manufacturing techniques and processes, such as welding, molding, milling, drilling, bending, fastening, soldering, etc., as known to one of ordinary skill in the art.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. An outdoor cooking station configured to expand or minimize useable surface space adjacent the cooking station, the outdoor cooking station comprising:
a main body including one or more heating elements configured to be supported by the main body; and
a side shelf system coupled to one side of the main body, the side shelf system including a first shelf, a second shelf, and a track system, the track system coupled to opposing interior sides of the first shelf and opposing exterior sides of the second shelf, the opposing interior sides of the first shelf defining an interior thereunder, the track system configured to facilitate sliding the second shelf relative to the first shelf.

2. The outdoor cooking station of claim 1, wherein the second shelf is sized and configured to be positioned within the interior of the first shelf.

3. The outdoor cooking station of claim 1, wherein the track system includes a lock and release lever configured to lock the second shelf within the interior of the first shelf and release the second shelf from the interior of the first shelf such that the side shelf system facilitates expanding and minimizing the useable surface space of the side shelf system.

4. The outdoor cooking station of claim 1, wherein the second shelf extends to define a second surface, the second surface extending to define a recess therein, the recess being sized and configured to receive a removable insert.

5. The outdoor cooking station of claim 4, wherein the removable insert is a bin.

6. A side shelf system configured to be coupled to a main body of a cooking station, the side shelf system comprising:
a first shelf extending with opposing interior sides to define an interior of the first shelf, the opposing interior sides coupled to a track system such that the track system is coupled to the opposing interior sides of the first shelf; and
a second shelf extending with opposing exterior sides, the second exterior sides coupled to the track system such that the second shelf is moveable relative to the first shelf.

7. The side shelf system of claim 6, wherein the second shelf is sized and configured to be positioned within the interior of the first shelf.

8. The side shelf system of claim 6, wherein the track system includes a lock and release lever configured to lock the second shelf within the interior of the first shelf and release the second shelf from the interior of the first shelf such that the side shelf system is extendable.

9. The side shelf system of claim 6, wherein the second shelf extends to define a second surface, the second surface extending to define a recess therein, the recess being sized and configured to receive a removable insert.

10. The side shelf system of claim 9, wherein the removable insert is a bin.

11. A method for modifying useable surface area associated with a cooking station, the method comprising:
providing a main body of a cooking station, the main body including a side shelf system coupled thereto, the side shelf system including a first shelf, a second shelf and a track system, the first shelf extending to define opposing interior side surfaces and the second shelf extending to define opposing exterior side surfaces, the track system positioned between and coupled to the interior side surfaces of the first shelf and the exterior side surfaces of the second shelf; and
engaging the track system by pulling on the second shelf so that the second shelf is movable relative to the first shelf to move the side shelf system to an expanded position or a compacted position.

12. The method according to claim 11, wherein the engaging comprises expanding the useable surface area by moving the second shelf from an underside of the first shelf.

13. The method according to claim 11, wherein the engaging comprises minimizing the useable surface area by pushing the second shelf to an underside of the first shelf.

14. The method according to claim 11, wherein the engaging comprises manually moving a lever to unlock the track system to facilitate moving the second shelf relative to the first shelf.

15. The method according to claim 11, further comprising pulling the second shelf from an underside of the first shelf to expose additional useable surface area provided by the second shelf.

16. The method according to claim 15, wherein the pulling comprises exposing a removable insert positioned in the second shelf.
